(19) United States
(12) Patent Application Publication
(10) Pub. No.: US 2011/0096723 A1
(43) Pub. Date: Apr. 28, 2011

(54) RADIO COMMUNICATION BASE STATION DEVICE, CORE NETWORK DEVICE, RADIO COMMUNICATION SYSTEM, RADIO COMMUNICATION TERMINAL, AND RADIO COMMUNICATION METHOD

(75) Inventors: Takahisa Aoyama, Kanagawa (JP); Akito Fukui, Kanagawa (JP)

(73) Assignee: PANASONIC CORPORATION, Osaka (JP)

(21) Appl. No.: 12/673,066

(22) PCT Filed: Aug. 13, 2008
(86) PCT No.: PCT/JP2008/002210

§ 371 Date: Feb. 11, 2010

(30) Foreign Application Priority Data
Aug. 14, 2007 (JP) 2007-211547

(51) Int. Cl. H04W 88/08; H04W 88/02

(52) U.S. Cl. 370/328

(57) ABSTRACT

A radio communication base station device, core network device, radio communication system, radio communication terminal, and radio communication method all enabling reduction of the delay caused when a call connection is carried out simultaneously even when security setting and data channel setting are both carried out when the first call connection is carried out. In attaching stored setting information by an index imparting method different with each terminal, a base station sets security for a terminal and transmits it to the terminal. In call connection, the base station checks the status of the stored setting information transmitted from the terminal and the stored setting information list and transmits the index to the terminal under the condition that the CN, the base station, and the terminal hold common stored setting information.

### TECHNICAL FIELD

The present invention relates to a radio communication base station apparatus, a core network apparatus, a radio communication system, a radio communication terminal apparatus and a radio communication method using pre-configuration.

### BACKGROUND ART

In 3GPP (3rd Generation Partnership Project), LTE (Long Term Evolution) has been standardized as a next generation mobile communication system. In Non-Patent Document 1, the operations upon setting up a call by a terminal are discussed. This summary of the operations will be explained using FIG. 1. In step 11 (hereinafter “ST”), by transmitting a random access preamble to a base station from a terminal and by transmitting a random access response to the terminal from the base station, the RACH procedure is carried out between the terminal and the base station to assign resources to the terminal.

In ST 12, the terminal transmits an RRC connection request (RRC message) to the base station using the resources assigned in the RACH procedure in ST 11. This RRC connection request also includes NAS-related information,

If other terminals transmit an RRC connection request at the same time in ST 12, in ST 13, by performing RRC contention resolution, in which the UE IDs included in the RRC connection request received by the base station are transmitted to terminals, the base station notifies the terminal which terminals have received those RRC connection requests and which terminals have not received those RRC connection requests when a plurality of terminals transmit an RRC connection request using the same resources.

In ST 14, the base station notifies the CN (Core Network) in a NAS message that the terminal is requesting a service, and, as a result, the CN notifies the base station of information related to the terminal and information set up to the terminal in a NAS message. Here, although the NAS message is explained, the protocol between the base station and the CN may be used, or both the NAS message and the protocol may be used.

In ST 15, the base station transmits an RRC connection modification command message to the terminal, to set up security, and the terminal transmits an RRC connection modification complete message, to respond to the security setup. The RRC connection modification command message includes an algorithms to employ, required parameter values, starting times and so on.

In ST 16, the base station transmits an RRC connection modification command message to the terminal, to set up data channels, and the terminal transmits an RRC connection modification complete message, to respond to the data channel setup. As for the data channel setup, for example, radio bearer (RB), a transport channel and a physical channel are set up.

Here, by setting up data channels in ST 16 after security is set up in ST 15, it is possible to encrypt the data channel setup and prevent the data channel setup from leaking to other users. However, it takes time to process in series as such, and therefore, in 3GPP, studies are underway to transmit messages, transmitted separately in ST 15 and ST 16 at the same time in the base station.

By the way, as a method to reduce call setup delay, Non-Patent Document 2 discloses the method of reducing the size of messages related to call setup, referred to as “pre-configuration” (a generic name for default configuration information, predefined configuration information and stored configuration information). Now, pre-configuration will be explained.

General call setup steps between a terminal and a network will be explained using FIG. 2. Here, packet connection, in which a terminal originates a call, will be explained as an example. In ST 21, the terminal transmits an RRC connection request message to the network. In ST 22, the network transmits an RRC connection setup message to the terminal in response to the RRC connection request message to notify the terminal of the UE identity, control information channel setup, and so on.

In ST 23, the terminal sets up channels of the terminal side according to the content notified in the RRC connection setup message, and transmits an RRC connection setup complete message to the network as a notice of this setup completion.

By processing from ST 21 to ST 23, RRC connection establishment is completed. Generally, with this RRC connection establishment, RB 1 (adopting RLC UM mode), RB 2 (adopting RLC AM and used to transmit RRC messages not including NAS messages), and RB 3 (adopting RLC AM and used to transmit RRC message including NAS messages) of SRBs (Signaling Radio Bearers), which are a radio bearers for transmitting control information, are established as channels. The content to set up for each channel besides the above RLC mode includes the priority of the channel, the PDU length of messages to transmit, the type of the transport channel to use and other transport information.

In ST 24, the terminal creates a CM service request, which is the NAS message to request the start of the service, and includes this in an initial direct transfer message, which is an RRC message, to transmit it to the network. The network starts managing the terminal in MM (Mobility Management) using the initial direct transfer message as a trigger. By the processing in ST 24, NAS connection establishment is completed.

In ST 25, the network includes an authentication request in a downlink direct transfer message, and transmits it to the terminal. Further, in ST 26, the terminal includes an authentication response in an uplink direct transfer message, and transmits it to the network. By this means, authentication is carried out between the terminal and the network.

In ST 27, the network transmits a security mode command message to the terminal, to notify the terminal of the setup for confidentiality and encryption including random number information to use in security. In ST 28, in response to the security mode command message, the terminal transmits a security mode complete message to the network at an uplink control timing. By this processing from ST 25 to ST 28, the authentication and the security procedure (security process) are completed.

In ST 29, the terminal includes an activate PDP context request in an uplink direct transfer message, and transmits a PDP context (a packet session) establishment request to the network. In ST 30, the network transmits a radio bearer setup message to the terminal, to set up an RAB (Radio Access Bearer), which is a traffic data communication channel.

In ST 31, the terminal transmits a radio bearer setup complete message to the network, to notify that an RAB can be set up correctly. In ST 32, the network notifies the terminal that PDP context establishment is completed finally by transmitting a PDP context establishment response included in a downlink direct transfer message. By this processing from ST 29 to ST 32, RAB setup and PDP context setup are completed.

In this way, call setup is carried out by the processing from ST 21 to ST 32. At this time, each message contains a large amount of information to transmit as setup information, and messages that contains a particularly the large amount of data include an RRC connection setup message (control information channel setup) and a radio bearer setup message (traffic data communication channel setup) to establish a radio channel, and it is possible to apply these messages to pre-configuration.

Two methods of pre-configuration are defined Non-Patent Document 3, based on the basic concept in which the terminal is made to hold representative information and the network notifies the terminal of indices only instead of transmitting any time radio channel establish information.

First, default configuration information will be explained. Default configuration information refers to information in which indices (32 types, but only 23 types are used in UMTS) are added to predetermined channel setup patterns (configuration information patterns), and, by making the terminal hold this default configuration information and by notifying the terminal of the indices, channel setup is realized without actual transmitting channel setup.

In this way, the information transmitted from the network (messages such as an RRC connection setup message and a radio bearer setup message) is indices only, so that it is possible to reduce the message size substantially, thereby reducing delay of call setup. Meanwhile, since defined channel setup patterns can only be adopted, operator-specific or terminal-specific setup are not allowed.

Next, pre-defined configuration information will be described. Pre-defined configuration information is transmitted in a channel that broadcasts channel setup patterns and the corresponding indices (16 types) from the network. The terminal receives the broadcast information transmitted from the network in an idle mode and so on, and holds the channel setup patterns and indices. The terminal notifies the network whether or not to hold the relationships between the channel setup and the indices, upon transmitting an RRC connection request message. When the network decides that the terminal has broadcast information, similar to default configuration information, the network is able to transmit indices alone, so that it is possible to reduce the message size and the delay of call setup. Although, in pre-defined configuration information, which is different from default configuration information, operator-specific setup is allowed, taking into account terminals not using channel setup transmitted with broadcast information, radio resources are used uselessly.

Also, there is a method, stored configuration information, which is explained in Non-Patent Document 2 but which is not standardized. Stored configuration information will be explained below.

With stored configuration information, when the network performs channel setup including RRC connection setup and radio bearer setup to the terminal, the network transmits channel setup patterns together with indices that show the channel setup patterns at the same time. The terminal side manages and holds the channel setup from the network using the indices transmitted at the same time. When the network side transmits channel setup messages including RRC connection setup messages and radio bearer setup messages next time, by transmitting these indices, the network side does not need to retransmit the large amount of channel setup information and therefore is able to make control such that each user holds necessary channel setup. Meanwhile, compared with configuration information such as default configuration information and pre-defined configuration information, with stored configuration information, all information requires transmission once using a dedicated channel.

FIG. 3 shows the communication steps using the stored configuration information for reference.

In this way, stored configuration information uses indices to set up data channels, and the information itself is not transmitted. Accordingly, when data channel setup and the suitable indices are encrypted upon transmission, even if only unencrypted indices are transmitted next, other users do not know how the actual setup is. Therefore, it is possible to use stored configuration information instead of encryption.
Non-Patent Document 1: 3GPP TS36.300 V8.1.0, “E-UTRA and E-UTRAN; Overall description; Stage2”
Non-Patent Document 2: 3GPP TR25.815 V7.0.0, “Signalling enhancements for CS and PS connections; Analyses and recommendations”
Non-Patent Document 3: 3GPP TS25.331 V7.5.0, “Radio Resource Control (RRC); Protocol specification”

### DISCLOSURE OF INVENTION

### Problems to be Solved by the Invention

However, even when the above-described stored configuration information is used, there is a problem of not being able to improve delay upon the initial call setup. Although, with Non-Patent Document 2, the message size of the initial call setup is reduced, this is because, with UMTS, security setup and data channel setup are always carried out in order. Meanwhile, with LTE, security setup and data channel setup are carried out at the same time upon the initial call setup, and therefore the influence of delay increases.

It is therefore an object of the present invention to provide a radio communication base station apparatus, a core network apparatus, a radio communication system, a radio communication terminal apparatus and a radio communication method that reduce delay of call setup even when security and data channels are set up at the same time upon the initial call setup.

### Means for Solving the Problem

The radio communication base station apparatus of the present invention adopts a configuration including: a receiving section that receives a command message to transmit stored configuration information from a core network; a stored configuration information creating section that creates the stored configuration information with which a plurality of items of call setup configuration information and a plurality of indices are associated; and a transmitting section that, when the command message is received, transmits the stored configuration information to a radio communication terminal apparatus.

The core network apparatus of the present invention adopts a configuration including: a stored configuration information creating section that creates stored configuration information associated with a plurality of items of call setup configuration information and a plurality of indices; and a transmitting section that transmits the stored configuration information to a radio communication base station apparatus.

The radio communication system of the present invention adopts a configuration including: a core network apparatus that comprises:
an attachment procedure section that carries out an attachment procedure with a radio communication terminal apparatus; and a transmitting section that transmits a command message to transmit stored configuration information; and a radio communication base station apparatus that comprises: a receiving section that receives the command message to transmit the stored configuration information; a stored configuration information creation section that creates the stored configuration information with which a plurality of items of call setup configuration information and a plurality of indices; and a transmitting section that, when the transmitting section receives the command message, transmits the stored configuration information to a radio communication terminal apparatus.

The radio communication terminal apparatus of the present invention adopts a configuration including: a broadcast information receiving section that receives predefined configuration information; a receiving section that receives stored configuration information with which a plurality of items of call setup configuration information and a plurality of indices; a holding section that holds default configuration information, the predefined configuration information and the stored configuration information; and a channel setup processing section that sets up a channel according to the stored configuration information, wherein stored configuration information indices are associated with default configuration information indices and predefined configuration information indices.

The radio communication method of the present invention includes steps of: receiving a command message to transmit stored configuration information from a core network; creating the stored configuration information associated with a plurality of items of call setup configuration information and indices; and transmitting the stored configuration information to a radio communication terminal apparatus when the command message is received.

### Advantageous Effects of Invention

According to the present invention, it is possible to reduce delay of call setup even when security and data channels are set up at the same time upon the initial call setup.

### BRIEF DESCRIPTION OF DRAWINGS

FIG. 1 is a sequence diagram showing the call setup steps in Non-Patent Document 1;

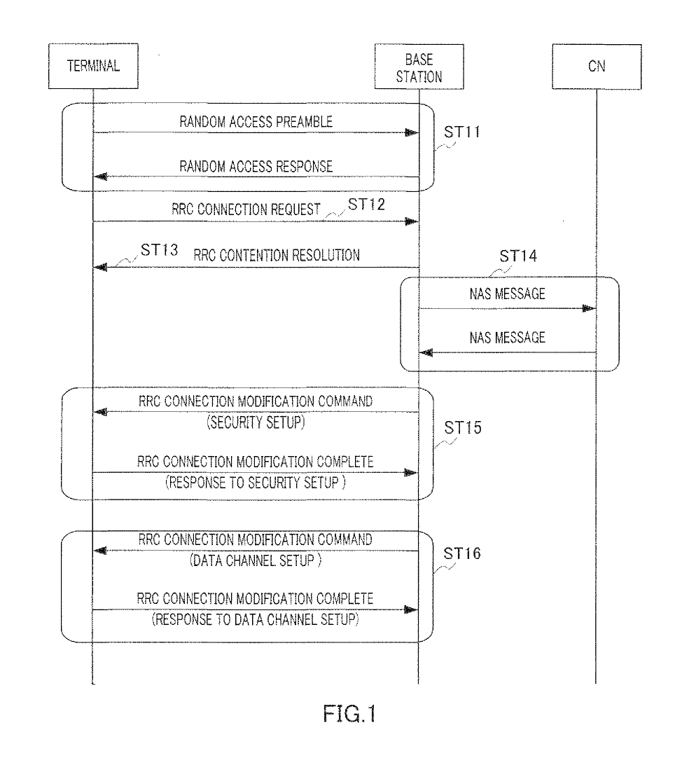

FIG. 2 is a sequence diagram showing general call setup steps between the terminal and the network;

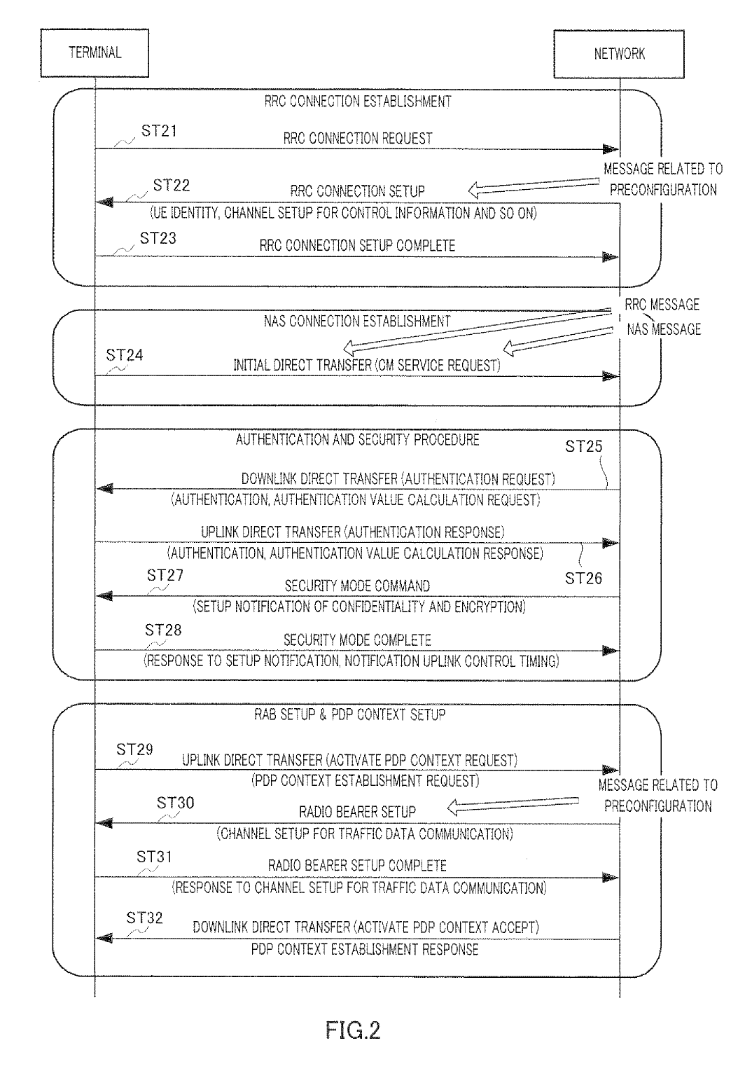

FIG. 3 is a sequence diagram showing the communication steps using stored configuration information;

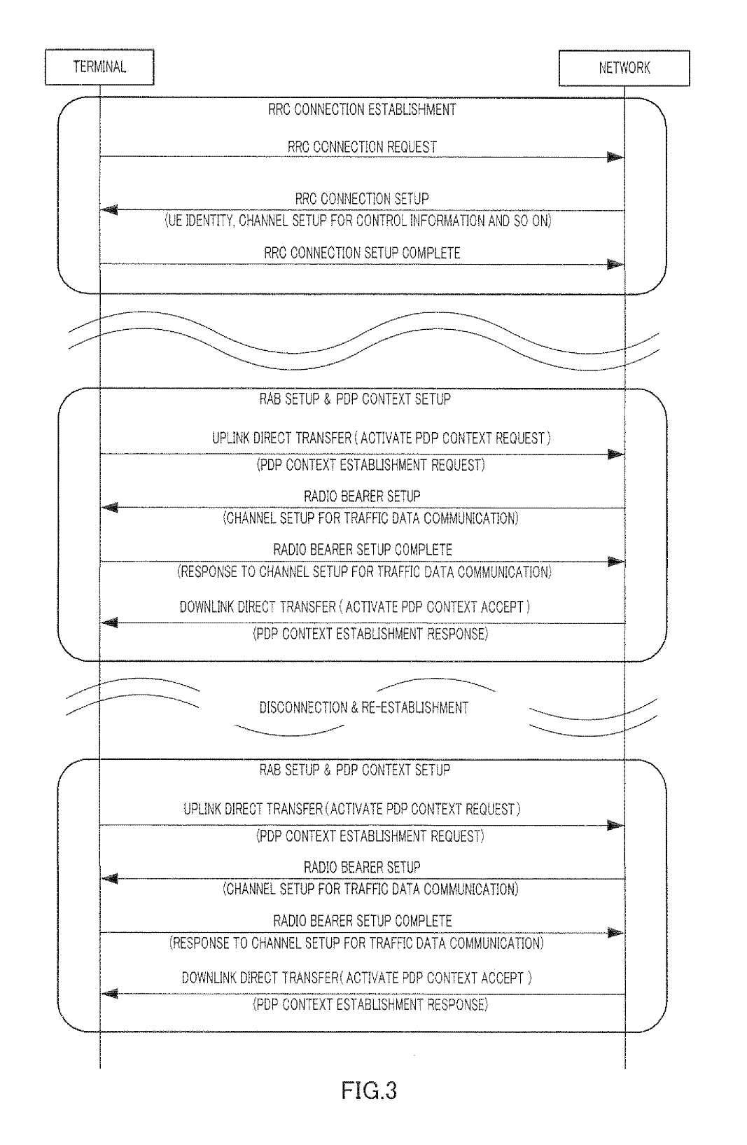

FIG. 4 is a block diagram showing the configuration of the CN according to Embodiment 1 of the present invention;

FIG. 5 is a block diagram showing the configuration of the base station apparatus according to Embodiment 1 of the present invention;

FIG. 6 is a block diagram showing the configuration of the terminal according to Embodiment 1 of the present invention;

FIG. 7 is a sequence diagram showing the communication steps among the CN shown in FIG. 4, the base station shown in FIG. 5 and the terminal shown in FIG. 6;

FIG. 8 is a sequence diagram showing other communication steps according to Embodiment 1 of the present invention;

FIG. 9 is a sequence diagram showing other communication steps according to Embodiment 1 of the present invention;

FIG. 10 is a block diagram showing the other configuration of the CN according to Embodiment 1 of the present invention;

FIG. 11 is a sequence diagram showing other communication steps according to Embodiment 1 of the present invention;

FIG. 12 is a block diagram showing the configuration of the base station according to Embodiment 2 of the present invention;

FIG. 13 is a block diagram showing the configuration of the terminal according to Embodiment 2 of the present invention;

FIG. 14 is a sequence diagram showing the communication steps among the base station shown in FIG. 12, the terminal shown in FIG. 13 and the CN;

FIG. 15 is a block diagram showing the configuration of the base station according to Embodiment 3 of the present invention;

FIG. 16 is a block diagram showing the configuration of the terminal according to Embodiment 3 of the present invention;

FIG. 17 is a sequence diagram showing the communication steps among the base station shown in FIG. 15, the terminal shown in FIG. 16 and the CN;

FIG. 18 is a block diagram showing the configuration of the base station according to Embodiment 4 of the present invention;

FIG. 19 is a block diagram showing the configuration of the terminal according to Embodiment 4 of the present invention; and

FIG. 20 is a sequence diagram showing the communication steps among the base station shown in FIG. 18, the terminal shown in FIG. 19 and the CN.

### BEST MODE FOR CARRYING OUT THE INVENTION

Now, embodiments of the present invention will be described in detail with reference to the accompanying drawings. In the embodiments, the components having the same functions will be assigned the same reference numerals and overlapping descriptions will be omitted.

### Embodiment 1

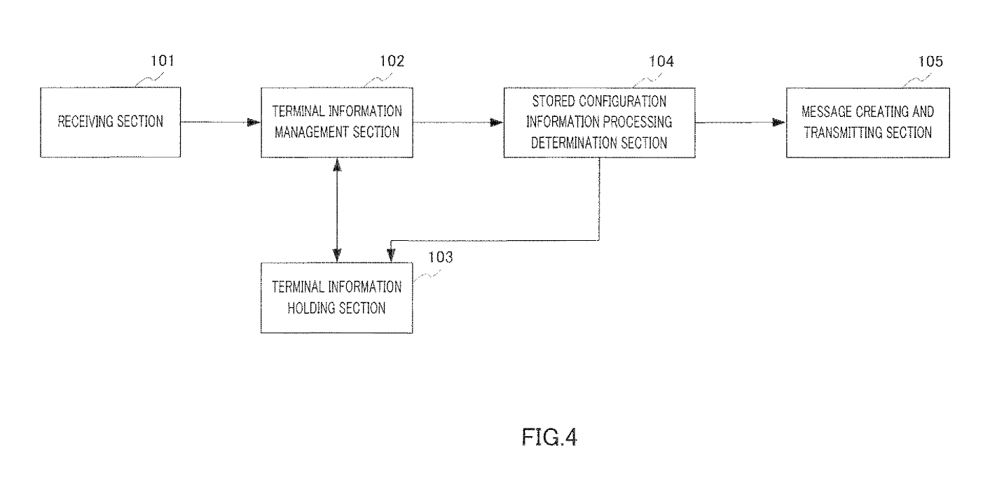

The core network (hereinafter referred to as the “CN”) according to Embodiment 1 of the present invention will be explained using FIG. 4. Receiving section 101 receives a message transmitted from a radio communication base station apparatus (hereinafter simply a “base station”) and outputs the received information to terminal information management section 102.

From the message outputted from receiving section 101, terminal information management section 102 extracts terminal information including the ID of the radio communication terminal apparatus (hereinafter simply “terminal”), contract information on the terminal, security information on the terminal and channel setup information held by the terminal (hereinafter, the method of transmitting both channel setup information and indices (identifiers) of that channel setup information using a channel other than broadcast channels, for example, a dedicated channel, holding these on the terminal side and notifying the terminal of the indices only upon the subsequent setup, is referred to as “stored configuration information scheme”), and outputs the extracted terminal information to terminal information holding section 103 and stored configuration information processing determination section 104. Further, terminal information management section 102 acquires and updates terminal information from terminal information holding section 103, and outputs the updated terminal information to terminal information holding section 103 and stored configuration information processing determination section 104.

Terminal information holding section 103 holds the terminal information outputted from terminal information management section 102, and outputs the corresponding terminal information to terminal information management section 102 in response to a request from terminal information management section 102. Further, terminal information holding section 103 holds the stored configuration-related information outputted from stored configuration information processing determination section 104.

Stored configuration information processing determination section 104 determines a stored configuration information scheme to set up to the terminal, based on the terminal information outputted from terminal information management section 102. For example, at attachment (for example, when the terminal is powered on or the terminal moves in a service area from outside the service area), stored configuration information processing determination section 104 commands the base station to transmit stored configuration information and determines the content to include in this transmission command. Further, when the terminal sets up a call, stored configuration information processing determination section 104 determines to transmit to the base station the stored configuration information given to the terminal. The information determined in this way is outputted to message creating and transmitting section 105.

Message creating and transmitting section 105 creates a message based on the information outputted from stored configuration information processing determination section 104, and outputs the created message to the base station.

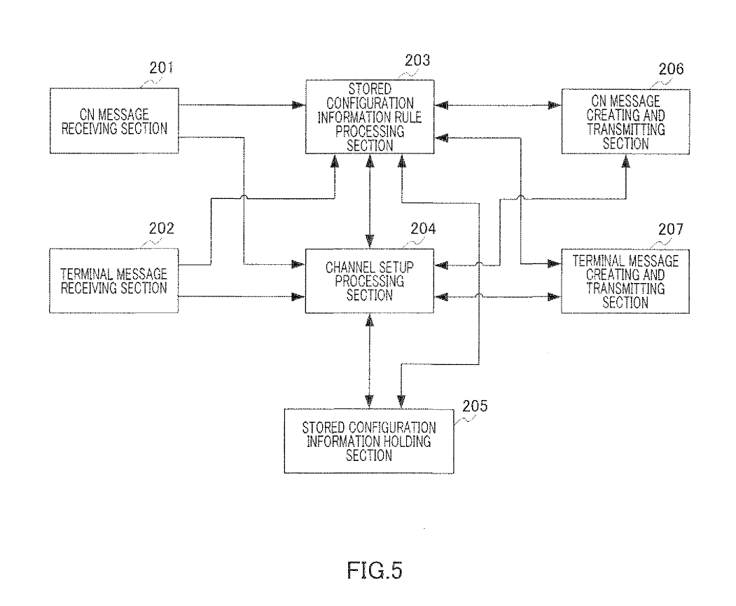

The configuration of the base station according to Embodiment 1 of the present invention will be explained using FIG. 5. CN message receiving section 201 receives a message transmitted from the CN, and, outputs the stored configuration-related information in the received message to stored configuration information rule processing section 203, and outputs the rest of the channel setup information to channel setup processing section 204. Here, the stored configuration-related information includes information for which the base station sets up stored configuration information for the terminal, or information on stored configuration information. Further, channel setup information includes contents of channel setup and security setup for the terminal.

Terminal message receiving section 202 receives a message transmitted from the terminal, and, outputs stored configuration-related information in the received message to stored configuration information rule processing section 203, and outputs the rest of the channel setup information to channel setup processing section 204. Here, the stored configuration-related information includes a state of stored configuration information transmitted by the terminal. Further, the channel setup information includes a response to channel setup and security setup from the base station.

Upon channel setting, stored configuration information rule processing section 203 makes stored configuration information holding section 205 hold the state of stored configuration information outputted from terminal message receiving section 202 as terminal state. Further, stored configuration information rule processing section 203 checks whether or not the stored configuration information outputted from CN message receiving section 201 matches the terminal state held in stored configuration information holding section 205. Here, when they match, based on the stored configuration information outputted from CN message receiving section 201, stored configuration information rule processing section 203 generates a stored configuration information list, and outputs the generated list to stored configuration information holding section 205. Further, when stored configuration information is held by the terminal, based on the state of the stored configuration information outputted from terminal message receiving section 202, stored configuration information rule processing section 203 generates a stored configuration information list, and outputs the generated list to stored configuration information holding section 205 and terminal message creating and transmitting section 207. Also, stored configuration information rule processing section 203 outputs that information to CN message creating and transmitting section 207. This timing may come before or after notifying the terminal of the stored configuration information.

Channel setup processing section 204 acquires the service type, that quality of service (QoS) and so on from the channel setup information outputted from CN message receiving section 201, and determines the channel setup to realize these. Here, when the stored configuration information is used, channel setup processing section 204 acquires the indices of the channel setup to use from stored configuration information holding section 205, and outputs the acquired indices to terminal message creating and transmitting section 207. Further, channel setup processing section 204 notifies or transfers to CN message creating and transmitting section 206 the result of response to the channel setup and the security setup outputted from terminal message receiving section 202,

Stored configuration information holding section 205 holds the stored configuration information list outputted from stored configuration information rule processing section 203, and, from the held stored configuration list, channel setup processing 204 reads the indices of the corresponding channel setup.

CN message creating and transmitting section 206 creates a message including the response to the stored configuration information list outputted from stored configuration information rule processing section 203 or to the channel setup and the security setup outputted from channel setup processing section 204, and outputs the created message to the CN.

Terminal message creating and transmitting section 207 creates a message including the stored configuration information list outputted from stored configuration information rule processing section 203 or the indices outputted from channel setup processing section 204, and outputs the created message to the terminal.

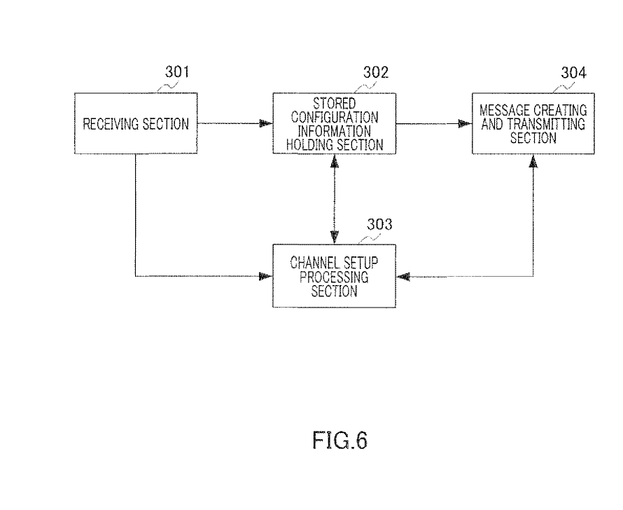

The configuration of the terminal according to Embodiment 1 of the present invention will be described using FIG. 6. Receiving section 301 receives a message transmitted from the base station, and, outputs stored configuration-related information in the received message, to stored configuration information holding section 302 and outputs the rest of channel setup information to channel setup processing section 303.

Stored configuration information holding section 302 holds the stored setup-related information outputted from receiving section 301. At this time, when it is necessary to notify the base station that the terminal has held the stored configuration-related information, stored setup information holding section 302 notifies message creating and transmitting section 304 of that event. Further, channel setup processing section 303 reads the stored configuration information held in stored configuration information holding section 302.

Channel setup processing section 303 performs channel setup based on the channel setup information outputted from receiving section 301. At this time, in cases where the channel setup information outputted from receiving section 301 is the indices of the stored configuration information, channel setup processing section 303 acquires from stored configuration information holding section 302 channel setup information corresponding to the indices, and sets up channels based on the acquired channel setup information.

Message creating and transmitting section 304 creates a message including the information notified from stored configuration information holding section 302, and transmits the created message to the base station.

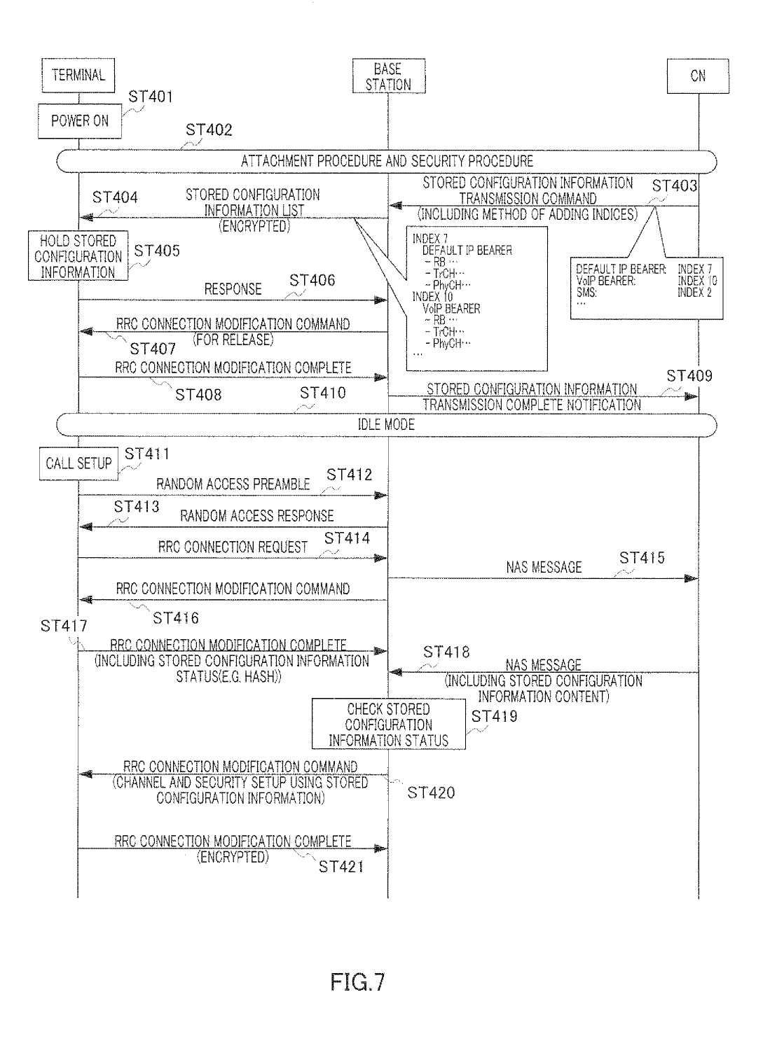

Next, the communication steps of the CN, the base station and the terminal having the above configurations will be described using FIG. 7. In ST 401, the terminal is powered on. In ST 402, attachment procedure (“attach procedure”) is started and a security procedure including authentication and encryption setup is also started.

In ST 403, the CN commands the base station to transmit stored configuration information during the process of the attachment procedure. This stored configuration information transmission command shows the method of adding indices. That is, the correspondence relationships between channels or bearers and indices, are notified. For example, the CN associates the IP default bearer to transmit an SIP (Session Initiation Protocol) message with index 7 and associates the VoIP bearer to carry out voice over IP (VoIP) with index 10, and notifies the terminal.

At this time, the security setup and contract information on the terminal are held in terminal information holding section 103 in the CN, and terminal information management section 102 acquires the held contract information and so on from terminal information holding section 103, and notifies the acquired contract information to stored configuration information processing determination section 104. Stored configuration information processing determination section 104 determines the service to offer to the terminal based on that contract information, and so on, and determines to make the terminal hold bearers for carrying out the service to offer to that terminal (in LTE, described as “SAE radio bearers”) as stored configuration information. To be more specific, IP default bearer transmitting SIPs (Session Initiation Protocols) and VoIP bearer to carry out VoIP are included. The stored configuration information determined to be stored by the terminal is notified to terminal information holding section 103 and message creating and transmitting section 105. Here, terminal information holding section 103 holds the notified information and message creating and transmitting section 105 produces information related to bearers set up in the terminal, to transmit the base station.

In ST 404, the base station transmits the stored configuration information list to the terminal. At this time, CN message receiving section 201 in the base station receives information transmitted from the network in ST 403, and outputs the received information to stored configuration information rule processing section 203. Stored configuration information rule processing section 203 makes stored configuration information holding section 205 hold the acquired information. Further, stored configuration information rule processing section 203 generates the stored configuration information list from the acquired information, and outputs the generated list to terminal message creating and transmitting section 207, and terminal message creating and transmitting section 207 creates a message including the stored configuration information list in the terminal and transmits the created message to the terminal.

In ST 405, receiving section 301 in the terminal receives the stored configuration information list transmitted from the base station in ST 404, and makes stored configuration information holding section 302 hold the received stored configuration information list. If stored configuration information holding section 302 holds the stored configuration-related information correctly, stored configuration information holding section 302 notifies message creating and transmitting section 304 of that event. In ST 406, message creating and transmitting section 304 creates a response message and transmits the created message to the base station, ST 406 can be omitted,

In ST 407, the base station transmits the RRC connection modification command message making the terminal shift to an idle mode. In ST 408, the terminal returns to the base station an RRC connection modification complete message as a response.

In ST 409, the base station transmits stored configuration information transmission complete notification to the CN. At this time, terminal message receiving section 202 in the base station receives the response message in ST 406. Here, the received response message is stored configuration-related information, and therefore is outputted to stored configuration information rule processing section 203. Stored configuration information rule processing section 203 checks the response is “OK” and notifies terminal message creating and transmitting section 207 that transmission of the stored configuration information has been correctly finished. CN message creating and transmitting section 206 creates the message to notify that transmission of the stored configuration information has been correctly finished, and transmits the created message to the CN. ST 409 can be omitted, and the base station is able to return the response when the base station receives the message in ST 403 from the CN. In this case, ST 409 and ST 404 are processed in parallel after ST 403. Further, in ST 409, the response from the terminal may be transmitted immediately after ST 406.

Further, receiving section 101 in the CN receives the message in ST 409 and outputs the received message to terminal information management section 102. Terminal information management section 102 notifies terminal information holding section 103 that the content determined to be transmitted to the terminal as the stored configuration information, has been correctly transmitted.

By these processing from ST 401 to ST 409, the stored configuration information is set up in both the terminal and the CN.

In ST 410, by the messages in ST 406 and ST 407, the terminal, the base station and the CN shift to an idle mode.

In ST 411, the terminal originates a call. Although a case is shown here where the terminal originates a call, even when the terminal receives a call (receives paging), only the operation of receiving paging is added, and receiving paging is essentially the same as originating a call.

In ST 412, the terminal transmits to the base station a random access preamble to request synchronization and resource allocation to the terminal. In ST 413, the base station transmits to the terminal timing information to make a terminal synchronize (the amount of shifting a transmission timing in the terminal) and a random access response designating resource allocation, and in ST 414, the terminal transmits to the base station the RRC connection request using the resources allocated by the random access response.

In ST 415, the base station transmits a NAS message including information designating the terminal (UE ID) to the CN, By this means, the CN acquires the stored configuration-related information and so on of the terminal. Here, NAS refers to a non-access stratum showing overall control on the core network side in charge of call processing and so on.

In ST 416, the base station transmits the RRC connection modification command message corresponding to RRC contention resolution. Here, the reason for using an RRC connection modification command message requiring a response message, is to transmit a stored configuration status according to this response message. If it is not necessary to transmit the stored configuration status in ST 416, by transmitting RRC contention resolution message, it is not necessary to transmit the response message. However, the RRC connection modification command message may be always used for notifying other information.

In ST 417, in response to the message in ST 416, the terminal transmits to the base station an RRC connection modification complete message including the stored configuration status showing the state of the terminal of the stored configuration information. At this time, channel setup processing section 303 in the terminal checks the present state to stored configuration information holding section 302, and outputs the stored configuration status to message creating and transmitting section 304. Message creating and transmitting section 304 creates the message including the stored configuration status, and transmits the created message to the base station. Terminal message receiving section 202 in the base station receives the message in ST 417, and outputs the stored configuration-related information in the received message to stored configuration information rule processing section 203. Stored configuration information rule processing section 203 makes stored configuration information holding section 205 hold the stored related information, which is used upon receiving the stored configuration information on the terminal from the CN.

In ST 418, the CN transmits to the base station a NAS message including stored configuration-related information in response to the NAS message in ST 415. At this time, receiving section 101 in the CN receives the NAS message in ST 415 and outputs the received NAS message to terminal information management section 102. Terminal information management section 102 checks the received ID and the service request from the terminal, and notifies terminal information holding section 103 to output the information related to the terminal. As the terminal information, terminal information holding section 103 outputs the terminal security information, control related information allowed to the terminal including QoS, and held stored configuration information, to terminal information management section 102. Based on the information acquired from terminal information holding section 103, terminal information management section 102 determines conditions related to the setup between the CN and the base station and between the terminal and the base station. The determined content and the result of the stored configuration information are outputted to stored configuration information processing determination section 104. Stored information processing determinations section 104 checks that there is no problem with the stored configuration information transmitted to the terminal, and transfers the information acquired from terminal information management section 102 to message creating and transmitting section 105. Message creating and transmitting section 105 creates a message related to the setup between the CN and the base station, and the setup between the terminal and the base station, a message showing the stored configuration information having been transmitted to the terminal and a message showing the security information to set up to the terminal, and transmits the messages to the base station. These messages are not necessarily all separate, and some or all of these are grouped as one message. Here, in ST 418, these messages are transmitted as one message without particularly separating.

In ST 419, the base station checks whether or not the information held in the terminal and the information held in the CN are the same, and determines the setup for the terminal. In ST 420, the base station sets up for the terminal channels and security using the stored configuration information, and in ST 421, the terminal sets up the channels using the stored configuration information, and transmits the response message to the base station. At this time, CN message receiving section 201 in the base station receives the message in ST 418. In the received message, CN message receiving section 201 outputs information related to the channel setup between the base station and the terminal and information related to security, to channel setup processing section 204, and outputs the stored configuration information to stored configuration rule processing section 203.

Then, stored configuration information rule processing section 203 holds the acquired stored configuration-related information and checks for stored configuration information holding section 205 whether or not the acquired stored configuration-related information and the information held by the terminal are the same. The information transmitted in ST 417 is used for this check. As a result of this check, if the acquired stored configuration-related information and the information held by the terminal are the same, the stored configuration information is used. On the other hand, if they differ, the stored configuration information cannot be used, and therefore varying messages are required to use between the security setup and the channel setup. Channel setup processing section 204 determines the content where the terminal is set up based on the acquired information. Further, channel setup processing section 204 checks for stored configuration rule processing section 203whether or not the stored configuration information suitable for the determined setup is held in the terminal.

If the suitable stored configuration information is held in the terminal, stored configuration rule processing section 203 returns the indices to channel setup processing section 204. If the suitable stored configuration information is not held in the terminal, stored configuration rule processing section 203 notifies channel setup processing section 204 of that event. If channel setup processing section 204 acquires the indices from stored configuration rule processing section 203, channel setup processing section 204 performs setup using the indices, and therefore determines to set up the security and the channels at the same time. On the other hand, if channel setup processing section 204 is notified from configuration rule processing section 203 that suitable stored configuration information is not held in the terminal, channel setup processing section 204 determines to use separate messages for the security setup and the channel setup. Channel setup processing section 204 notifies terminal message creating and transmitting section 207 of the determined content. Here, a case where the stored configuration information can be used will be explained. Channel setup processing section 204 has decided that the security setup and the channel setup can be set up in one message, and therefore terminal message creating and transmitting section 207 creates one such message for setting up channels using the indices in the stored configuration information and for setting up security and transmits the created message in ST 420.

Receiving section 301 in the terminal receives the message in ST 420, and outputs the received message to channel setup processing section 303. Channel setup processing section 303 outputs the indices of the received stored configuration information to stored configuration information holding section 302, and acquires the suitable setup from stored configuration information holding section 302. Then, channel setup processing section 303 sets up the channels together with the security setup received at the same time. As a result, when the step is finished correctly, channel setup processing section 303 notifies message creating and transmitting section 304 of correct completion. By this means, message creating and transmitting section 304 creates a message in response to the message in ST 420, and outputs the created message to the base station in ST 421.

In this way, according to Embodiment 1, by setting up security and transmitting stored configuration information upon attachment using varying index addition methods between terminals, from the base station to the terminal, by checking the stored configuration status and a stored configuration information list transmitted from the terminal upon setting up a call, and by transmitting from the base station to the terminal indices on the condition that common stored configuration information is held between the CN, the base station and the terminal, it is possible to reduce a delay and secure security even when the security and the data channels are set up at the same time upon setting up a call, so that it is possible to prevent the data channel setup from leaking to other users.

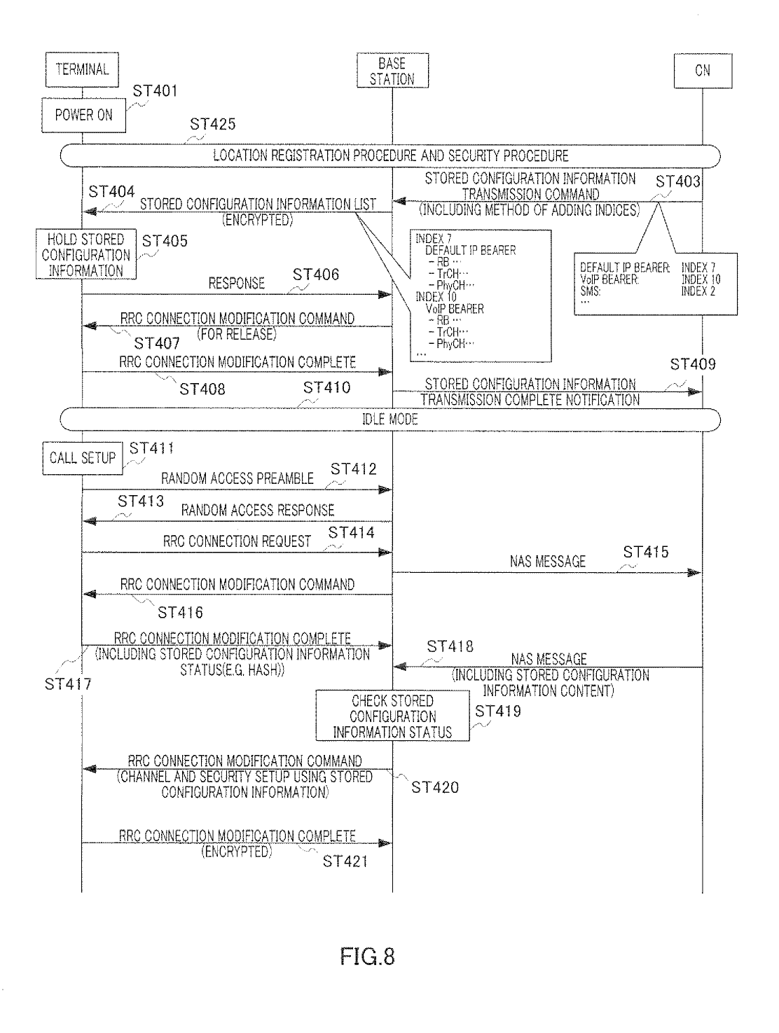

As described in the present embodiment, the method of transmitting stored configuration information upon attachment may be carried out after completion of the attachment procedure or during the attachment procedure, and, furthermore, may be carried out in a tracking area update procedure, which is the location registration procedure for the terminal other than the attachment procedure, or other methods may be carried out. FIG. 8 shows the location registration procedure. Here, FIG. 8 differs from FIG. 7 in changing ST 402 to ST 425, and in ST 425, the location registration procedure is carried out instead of the attachment procedure.

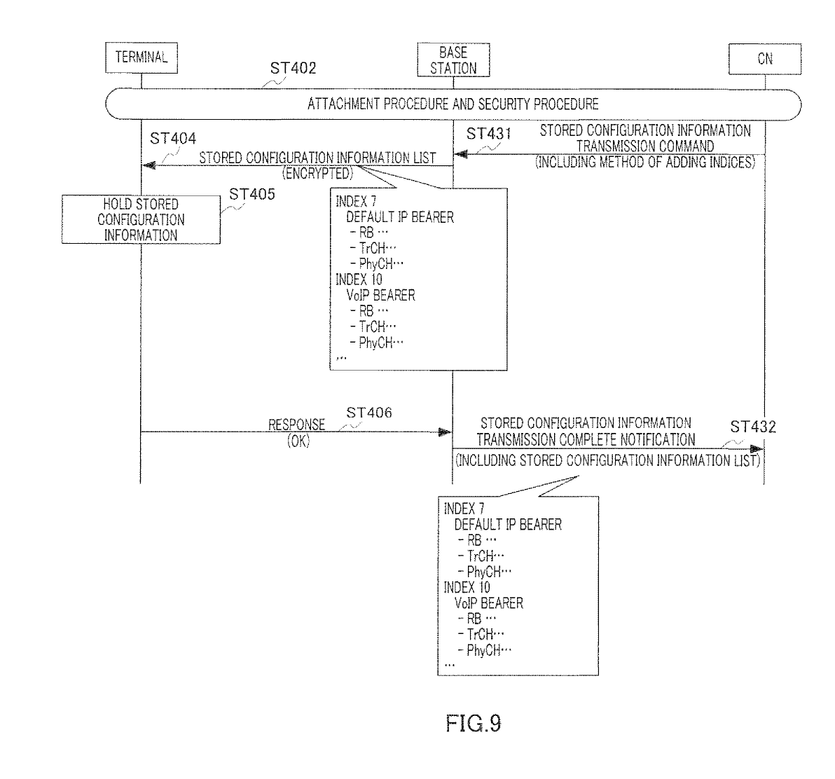

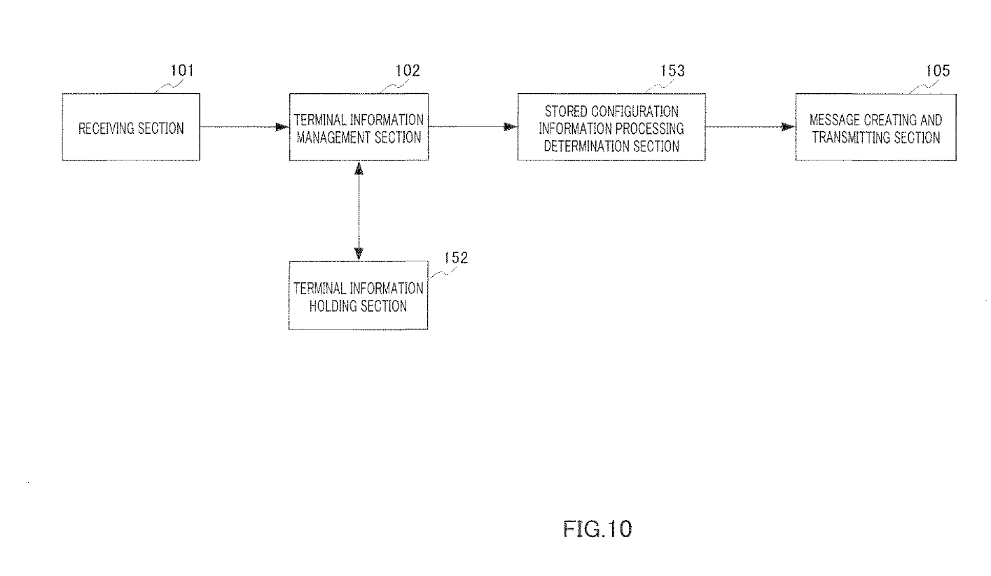

Although a case has been explained with the present embodiment where the CN commands the index addition method to the base station, the present embodiment is not limited to this, and the base station may add base-station specific indices. To be more specific, as shown in FIG. 9, in ST 431, the CN commands the base station to only carry out stored configuration information, and the base station adds indices freely. In ST 432, the base station returns to the CN a list of the indices added by the base station, that is, a stored configuration information list. By this means, it is possible to reduce the processing load of the CN. The information transmitted to the CN in ST 432 may only be held by the CN as information related to the terminal. Further, at this time, the CN does not determine the information made the terminal hold, so that the CN is able to be configured simple as shown in FIG. 10. In the base station, stored configuration information rule processing section 203 receives a command to set up the stored configuration information for the terminal via CN message receiving section 201, and determines the information to set up for the terminal.

Further, although a case has been explained with the present embodiment where the terminal includes the stored configuration status in the message in ST 417 shown in FIG. 7 and transmits the message to the base station, the stored configuration status may be included in the message in ST 414, and the state of the terminal and the state of the CN basically match, so that it is equally possible to omit to transmit the stored configuration status. When the stored configuration status is included in the message in ST 414, it is equally possible to notify that information in ST 415 and the CN determines the information.

Further, although a case has been explained with the present embodiment where the CN transmits the service-related information held in the terminal, the CN may transmit QoS related information accepted together with the service related information by the terminal. By this means, the base station is able to determine channel setup varying between terminals in accordance with the QoS. As a result, content matching the terminal is held in both the terminal and the CN, as stored configuration information.

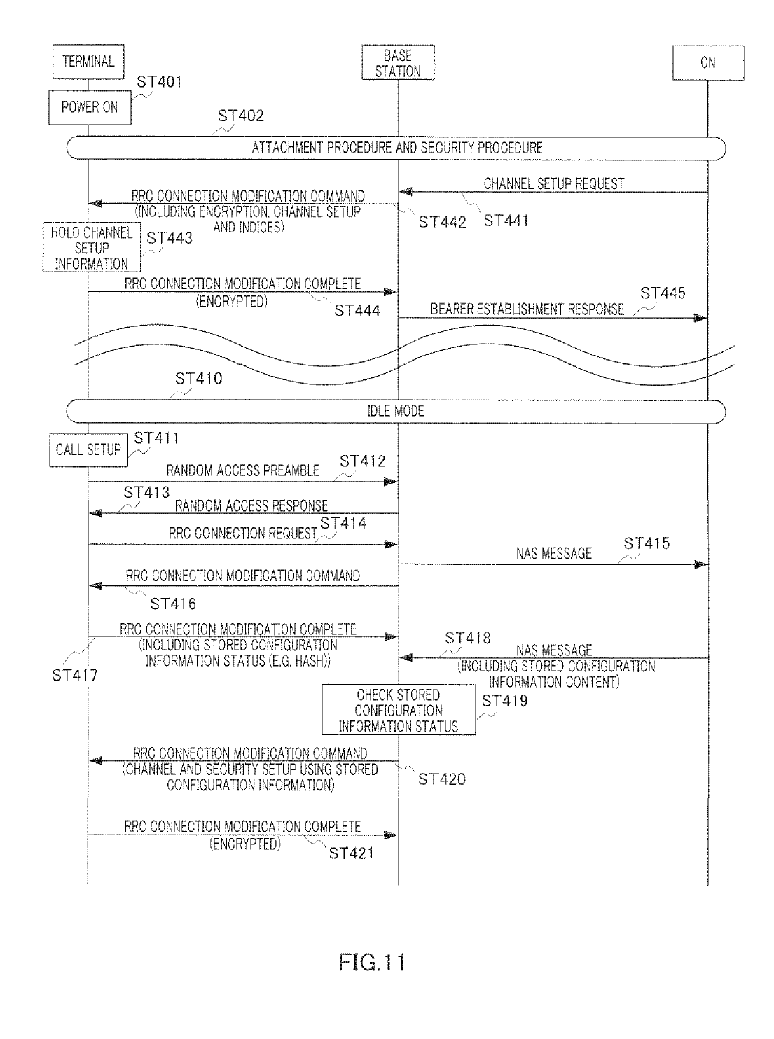

Further, when the information that the terminal is made to hold as stored configuration information is very limited (for example, one item of information), it is possible to actually provide a channel based on that channel setup. The operations at this time will be shown in FIG. 11. Here, in ST 441, the CN transmits a channel setup request to the base station, and, in response to that request, the base station sets up a channel for the terminal in ST 442. At this time, indices showing that channel setup are also notified. The terminal holds these contents (ST 443). After that, responses are transmitted as in ST 444 and ST 445. In a case where the channel setup to use after attachment is only one, these operations are possible.

Although a case has been explained with the present embodiment where only the channel setup is treated as stored configuration information similar to conventional stored configuration information, it is possible to treat information that is best notified for the terminal at the same time as the channel setup as stored configuration information even information other than the channel setup. To be more specific, possible information includes “measurement configuration,” set up in the terminal and “capability” of the base station. To realize this, one of indices in the stored configuration information may be defined so as to specify only measurement configuration or capability, or may notify the measurement configuration according to channel setup, or notify the combination of the capacity of base stations.

Although, with the present embodiment, the stored configuration information mode of the terminal notified to the base station by the terminal is not explained in detail, it is generally the case to use tags (hexadecimals) which show a version, and which are used in normal pre-configuration. Further, another possible method is to use Hash values for information to set up in the terminal based on a given rule. Furthermore, another possible method is to make rules for decisions as to which index is used for which service using information held between the terminal and the network side (e.g. the terminal ID (IMSI or S-TMSI), information about keys used in the security and the base station ID). To be more specific, the fact that the index of default IP bearer in FIG. 8 is 7 can be uniquely determined using the information held between the terminal and the network side. By this means, it is possible not to differ the information set up in the terminal.

Further, although only the operations to notify stored configuration information for the terminal first have been shown with the present embodiment, it is equally possible to update that information. To be more specific, by notifying the indices used up till then upon normal channel re-setup, it is equally possible to make those indices have the content of re-setup channels, and notify update information on the terminal separately. Further, taking into account the security, it is possible to update information upon call setup or upon release (every time or once in several times) and update information every special event, upon the location registration procedure for example.

### Embodiment 2

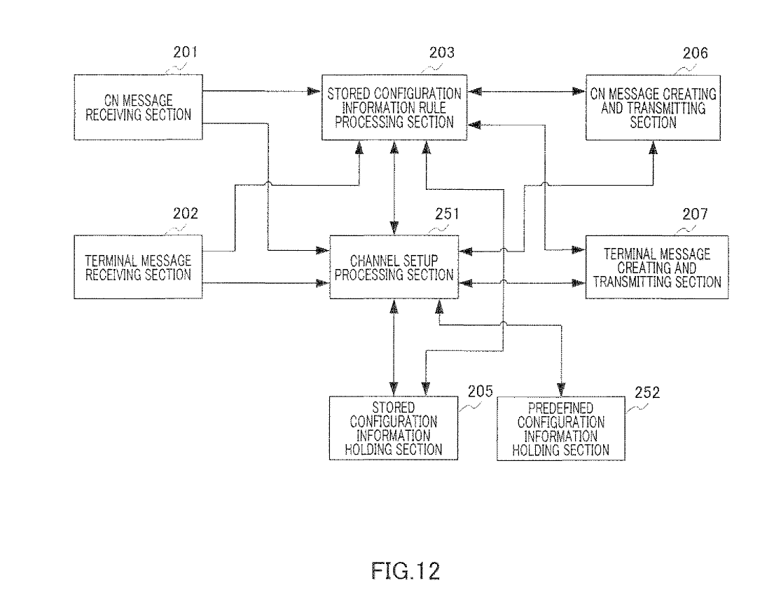

The configuration of the base station according to Embodiment 2 of the present invention will be explained using FIG. 12. FIG. 12 differs from FIG. 5 in changing channel setup processing section 204 to channel setup processing section 251 and adding predefined configuration information holding section 252.

Predefined configuration information refers to information associating a plurality of items of call setup configuration information with indices, and the information can be changed dynamically by the base station, To be changed dynamically, predefined configuration information is transmitted as broadcast information through a broadcast channel from the base station. Default configuration information refers to information associating a plurality of items of call setup configuration information with indices, and the information cannot be changed dynamically, and therefore it is not necessary to be transmitted as broadcast information.

Upon channel setup, channel setup processing section 251 determines to set up channels from a message outputted from CN message receiving section 201, and acquires predefined configuration information and default configuration information suitable for those from predefined configuration information holding section 252. Further, when the predefined configuration information is broadcasted, channel setup processing section 251 receives the predefined configuration information from predefined configuration information holding section 252, and outputs it to terminal message creating and transmitting section 207,

Upon channel setup, predefined configuration information holding section 252 selects the indices of the predefined . configuration information and the default configuration information suitable for the channel setup requested from channel setup processing section 251, and responds to the selected indices to channel setup processing section 251. Further, when the predefined configuration information is broadcasted, predefined configuration information holding section 252 notifies a predefined configuration information list of channel configuration processing section 251.

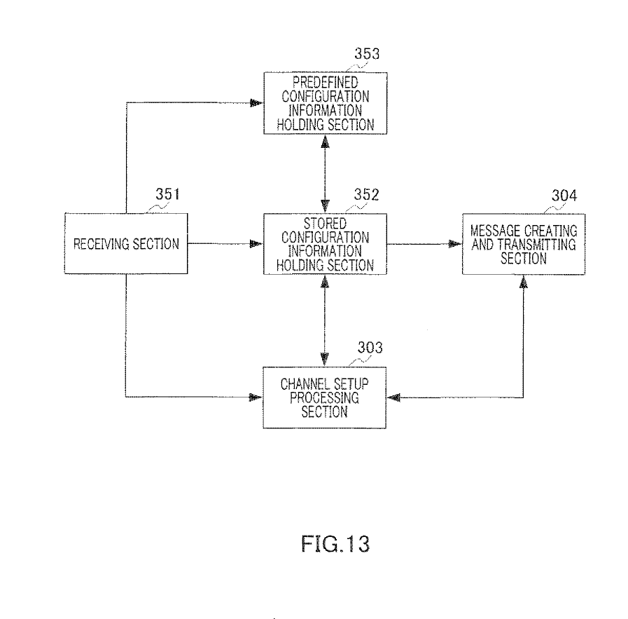

The configuration of the terminal according to Embodiment 2 of the present invention will be explained using FIG. 13. FIG. 13 differs from FIG. 6 in changing receiving section 301 to receiving section 351, changing stored configuration information holding section 302 to stored configuration information holding section 352, and adding predefined configuration information holding section 353.

Receiving section 351 receives predefined configuration information transmitted by broadcast information from the base station, and outputs the received predefined configuration information to predefined configuration information holding section 353.

Stored configuration information holding section 352 detects predefined configuration information indices associated with stored configuration information indices outputted from receiving section 351, acquires channel setup information associated with the detected predefined configuration information indices from predefined configuration information holding section 353, and outputs the acquired channel configuration information to channel setup processing section 303.

Predefined configuration information holding section 353 holds the predefined configuration information outputted from receiving section 351, and returns to stored configuration information holding section 352 information suitable for the indices outputted from stored configuration information holding section 352.

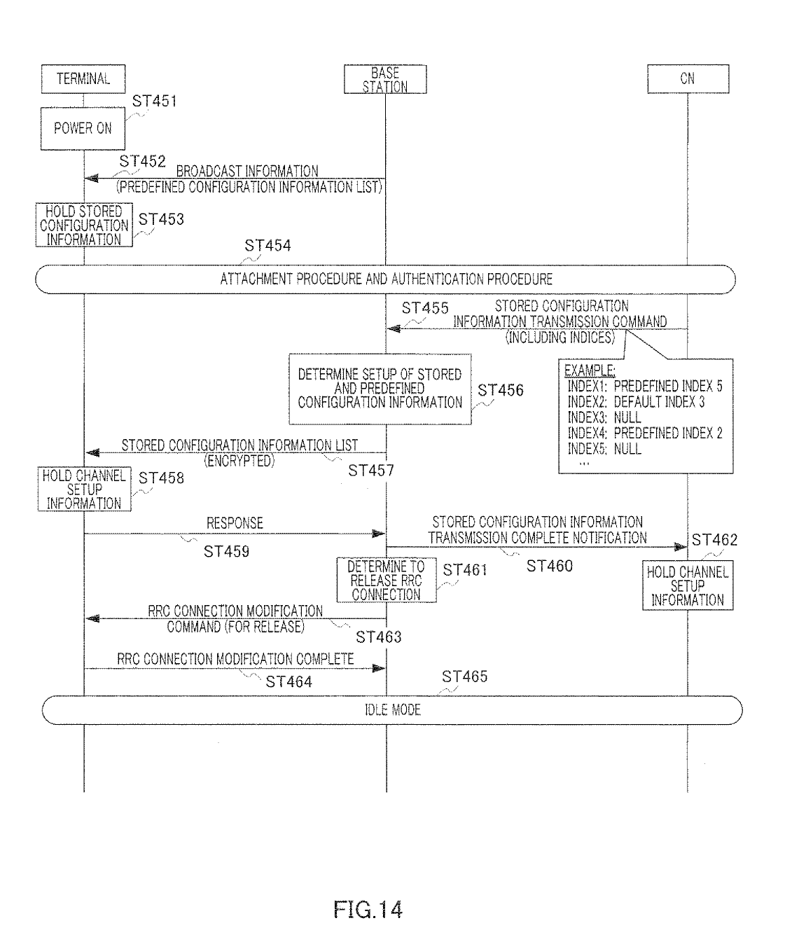

Next, the communication steps of the base station having the configuration shown in FIG. 12, the terminal having the configuration shown in FIG. 13, and the CN will be explained using FIG. 14. In ST 451, the terminal is powered on. In ST 452, the base station transmits the broadcast information including the predefined configuration information to the terminal. In ST 453, the terminal receives and holds the predefined configuration information transmitted from the base station.

In ST 454, the attachment procedure is started and the authentication procedure is also started.

In ST 455, the CN commands the base station to transmit stored configuration information during the process of the attachment procedure. This stored configuration information transmission command shows how to treat predefined configuration information indices and default configuration information indices in stored configuration information. For example, the setup shown with index 5 of the predefined configuration information is treated as index 1 of the stored configuration information, and the setup shown with index 3 of the default configuration information is treated as index 2 of the stored configuration information.

In ST 456, CN message receiving section 201 in the base station receives the message from CN in ST 455, and outputs the received information to stored configuration information rule processing section 203 because the received message is the stored configuration-related information. Stored configuration information rule processing section 203 determines to carry out setup according to the received message.

In ST 457, terminal message creating and transmitting section 207 in the base station transmits to the terminal the setup determined in ST 456. In ST 458, receiving section 351 in the terminal receives the setup transmitted from the base station in ST 457 and outputs the received setup to stored configuration information holding section 352.

By these processing steps, predefined configuration information is received by broadcast information in the terminal, and therefore it is likely that setup of predefined configuration information varies between base stations. Accordingly, the content set up in different base stations becomes invalid. Consequently, here, by setting up predefined configuration information varying between cells using the stored configuration information, it is possible to notify setup varying between cells in a secure manner.

Further, if the large amount of stored configuration information is held, the complexity of the CN and the terminal increases. However, by utilizing predefined configuration information and default configuration information in this way, it is possible to reduce information held by the terminal and the CN. ST 459 to ST 465 are based on ST 406 to ST 410 shown in FIG. 7 of Embodiment 1, and therefore the explanation will be omitted in detail.

In this way, according to Embodiment 2, by broadcasting varying setup between cells to the terminal using predefined configuration information, and by associating and transmitting the predefined configuration information indices with stored configuration information indices, varying setup between cells is able to be secured.

Although a case has been explained with the present embodiment where the content all transmitted by stored configuration information is predefined configuration information and default configuration information, in addition to those, it is possible to set up independent stored configuration information.

Further, also with the present embodiment, as shown in FIG. 9 of Embodiment 1, the CN may not determine the setup, and the base station may determine the setup. Further, it is equally possible to determine setup in the terminal.

Further, also with the present embodiment, it is possible to set up the stored configuration information using procedures other than attachment.

Further, with the present embodiment, if the content to be set up as stored configuration information is only index information on predefined configuration information and default configuration information, it is equally possible to prevent the setup operations themselves if the method of setting up indices is determined between the network side and the terminal side. To be more specific, amongst information held between the terminal and the network side (e.g. the terminal ID (IMSI or S-TMSI), information about keys used in the security and the base station ID), if rules are made to determine which index is used for which service, using information only the terminal and the network side know (e.g. information about a key used in the security), the terminal and the network side are able to determine the setup individually.

### Embodiment 3

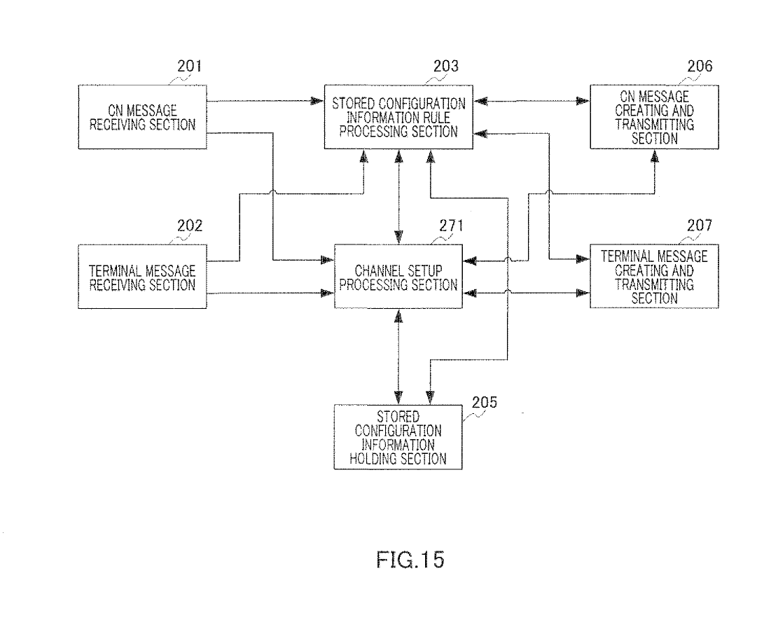

The configuration of the base station according to Embodiment 3 of the present invention will be explained using FIG. 15. FIG. 15 differs from FIG. 5 in changing channel setup processing section 204 to channel setup processing section 271.

Based on messages outputted from CN message receiving section 201 and terminal message receiving section 202, channel setup processing section 271 determines to set up channels separately for the content that cannot set up channels using stored configuration information, and notifies terminal message creating and transmitting section 207 of that event.

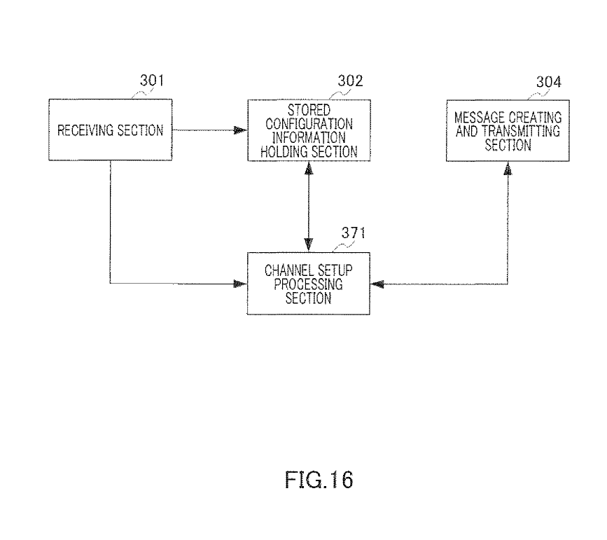

The configuration of the terminal according to Embodiment 3 of the present invention will be explained using FIG. 16. FIG. 16 differs from. FIG. 6 in changing channel setup processing section 303 to channel setup processing section 371.

Based on a message outputted from receiving section 301, channel setup processing section 371 sets up the content that cannot be set up using stored configuration information according to commands from the base station, and sets up the content set up using stored configuration information according to the indices.

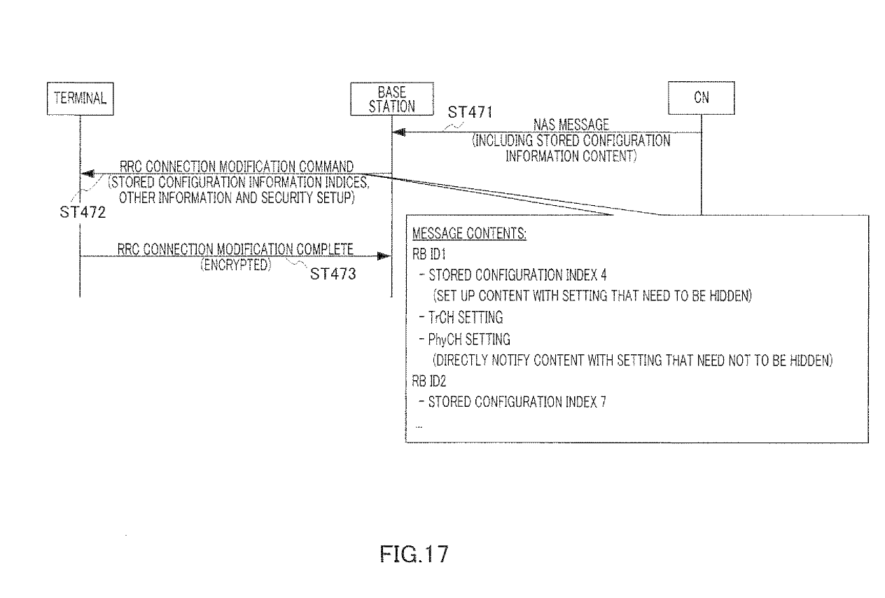

Next, the communication steps of the base station having the configuration shown in FIG. 15, the terminal having the configuration shown in FIG. 16, and the CN will be explained using FIG. 17. In ST 471, the CN transmits the NAS message including the stored configuration information to the base station. However, this stored configuration information does not include all information required for channel setup and include just part of it.

Channel setup processing section 271 in the base station determines to notify in the same message of the terminal the information, which cannot be set up using the stored configuration information transmitted from the CN in ST 471, and which is required for channel setup, and terminal message creating and transmitting section 207 transmits the message to the terminal in ST 472.

Based on the content set up separately in addition to the information notified by the stored configuration information indices, in ST 473, the terminal determines the setup of the terminal, and transmits RRC connection modification complete message to the base station in response to the message in ST 472.

In this way, according to Embodiment 3, by limiting information set up in the terminal as stored configuration information to information that requires secure transmission, and by transmitting information other than the limited information without encrypting the information, it is possible to reduce the information held as stored configuration information in the terminal and the CN.

Although the stored configuration information includes QoS information varying between terminals and operator-specific DRX values, other information may be applicable.

### Embodiment 4

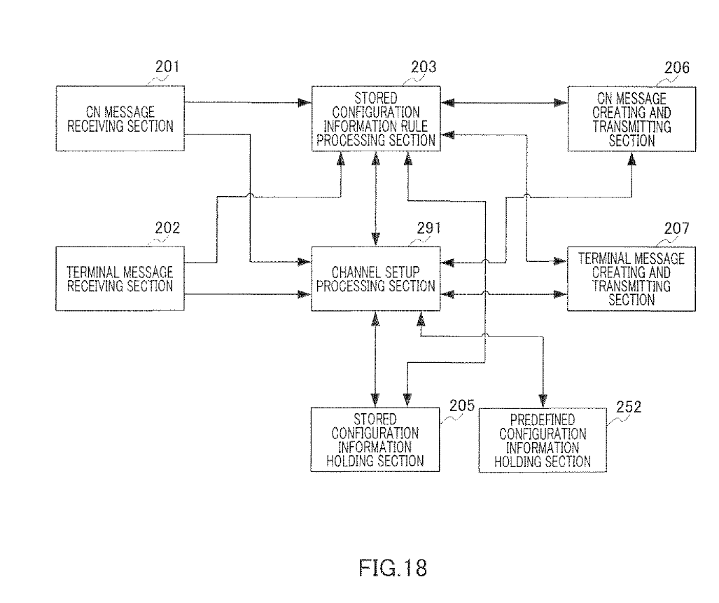

The configuration of the base station according to Embodiment 4 of the present invention will be explained using FIG. 18. FIG. 18 differs from FIG. 12 in changing channel setup processing section 251 to channel setup processing section 291.

Based on messages outputted from CN message receiving section 201 and terminal message receiving section 202, channel setup processing section 291 sets up channels using stored configuration information and predefined configuration information, or stored configuration information and default configuration information at the same time.

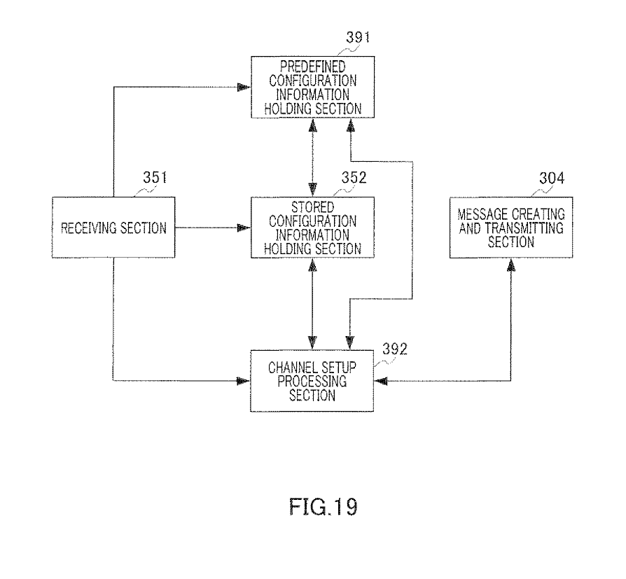

The configuration of the terminal according to Embodiment 4 of the present invention will be explained using FIG. 19. FIG. 19 differs from FIG. 13 in changing predefined configuration information holding section 353 to predefined configuration information holding section 391, and changing channel setup processing section 303 to channel setup processing section 392.

Predefined configuration information holding section 391 holds predefined configuration information and default configuration information included in a message outputted from receiving section 351, and outputs the held predefined configuration information and default configuration information to channel setup processing section 392. Here, possible content set up by the stored configuration information includes terminal-specific QoS-related information not modified in the network, and possible content set by the predefined configuration information includes base station-specific information that is common between terminals, including PhyCH (physical channel) setup.

According to the indices included in the message outputted from receiving section 351, channel setup processing section 392 acquires suitable channel setup information from stored configuration information holding section 352 and predefined configuration information holding section 391, to set up channels.

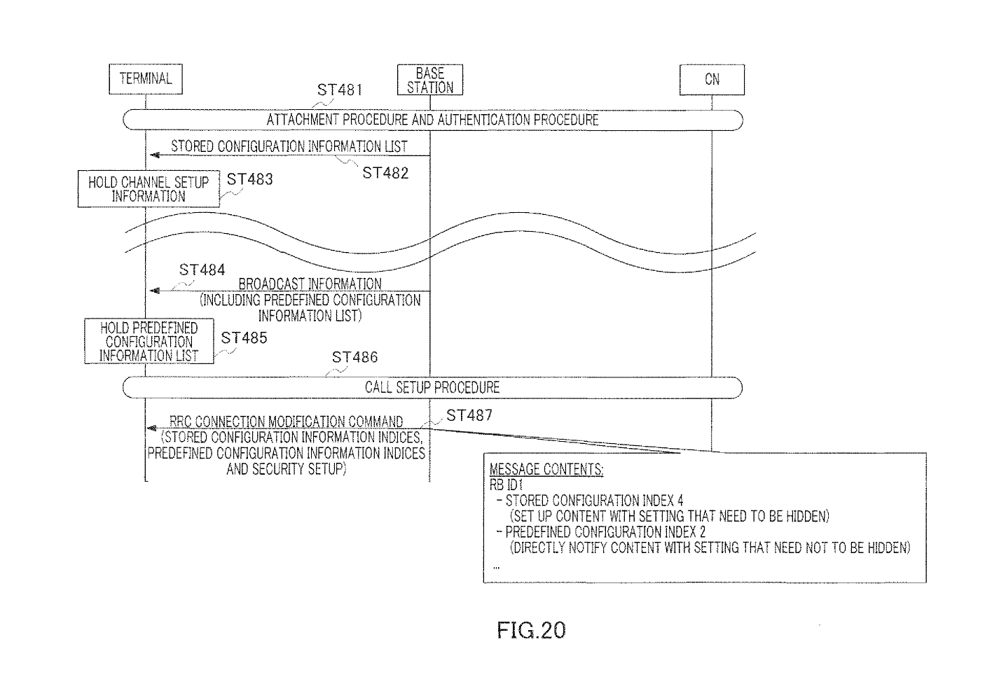

Next, the communication steps of the base station having the configuration shown in FIG. 18, the terminal having the configuration shown in FIG. 19, and the CN will be explained using FIG. 20. In ST 481, the attachment procedure is started and the authentication procedure is also started.

In ST 482, the base station transmits the stored configuration information list to the terminal. In ST 483, the terminal holds the stored configuration information list transmitted from the base station in ST 482.

In ST 484, the base station transmits the broadcast information including the predefined configuration information list to the terminal. In ST 485, the terminal receives and holds the predefined configuration information list transmitted from the base station.

In ST 486, the call setup procedure is carried out. In ST 487, the base station transmits to the terminal the stored configuration information indices and the predefined configuration information indices (or the default configuration information indices).

In this way, according to Embodiment 4, by separating the content set up by stored configuration information and the content set up by predefined configuration information and by using each of the indices, it is possible to reduce information held as stored configuration information in the terminal and the CN and secure security of varying setup between cells.

It is equally possible to completely separate the content set up by stored configuration information and the content set up by predefined configuration information, and, if the content can be set up to the stored configuration information and predefined configuration information, the content may be set up to both items of information with priority. Further, if the content cannot be set up for either of these, it is equally possible to set up the content additionally as shown in Embodiment 3.

Further, the content set up by stored configuration information includes user-specific information including QoS information, and includes information that is common between cells such as information related to the service itself. Further, the content set up by predefined configuration information includes information that is common between users such as radio channel setup and varying information between cells. These contents may be sorted and defined by the specifications or by operations by the operator.

Although specific protocols have been explained with the above embodiments, the present invention is not limited to these, and other protocols may be implemented. To be more specific, NAS messages may be messages using SI protocols discussed in 3GPP as control protocols between the base station and the CN, and may be messages using both NAS messages and SI protocol messages.

Also, although cases have been described with the above embodiment as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2007-211547, filed on Aug. 14, 2007, including the specification, drawings and abstract, is incorporated herein by reference in its entirety.

### INDUSTRIAL APPLICABILITY

The radio communication base station apparatus, the core network apparatus, the radio communication system, the radio communication terminal apparatus and the radio communication method according to the present invention are able to reduce delay upon setting up a call, and applicable to, for example, 3GPP LTE systems.

1. The radio communication base station apparatus comprising:
a receiving section that receives a command message to transmit stored configuration information from a core network;
a stored configuration information creating section that creates the stored configuration information with which a plurality of items of call setup configuration information and a plurality of indices are associated; and
a transmitting section that, when the command message is received, transmits the stored configuration information to a radio communication terminal apparatus.

2. The radio communication base station apparatus according to claim 1, wherein, when the command message is received after an attachment procedure of the radio communication terminal apparatus is finished, the transmitting section transmits the stored configuration information to the radio communication terminal apparatus.

3. The radio communication base station apparatus according to claim 1, wherein, when the command message is received after a location registration procedure of the radio communication terminal apparatus is finished, the transmitting section transmits the stored configuration information to the radio communication terminal apparatus.

4. The radio communication base station apparatus according to claim 1, further comprising a broadcast information transmitting section that transmits predefined configuration information as broadcast information,
wherein stored configuration information indices are associated with default configuration information indices or predefined configuration information indices.

5. The radio communication base station apparatus according to claim 1, wherein the stored configuration information varies between radio communication terminal apparatuses or between groups each formed with a plurality of radio communication terminal apparatuses.

6. A core network apparatus comprising:
a stored configuration information creating section that creates stored configuration information associated with a plurality of items of call setup configuration information and a plurality of indices; and
a transmitting section that transmits the stored configuration information to a radio communication base station apparatus.

7. The core network apparatus according to claim 6, further comprising:
an attachment procedure section that carries out an attachment procedure with a radio communication terminal apparatus,
wherein the transmitting section transmits the stored configuration information after the attachment procedure is completed.

8. The core network apparatus according to claim 6, further comprising:
a location registration procedure section that carries out a location registration procedure with a radio communication terminal apparatus,
wherein the transmitting section transmits the stored configuration information after the location registration procedure is completed.

9. The core network apparatus according to claim 6, wherein stored configuration information indices are associated with default configuration information indices or predefined configuration information indices.

10. The core network apparatus according to claim 6, wherein the stored configuration information varies between radio communication terminal apparatuses or between groups each formed with a plurality of radio communication terminal apparatuses.

11. A radio communication system comprising:
a core network apparatus that comprises:
an attachment procedure section that carries out an attachment procedure with a radio communication terminal apparatus; and
a transmitting section that transmits a command message to transmit stored configuration information; and
a radio communication base station apparatus that comprises:
a receiving section that receives the command message to transmit the stored configuration information from the network apparatus;
a stored configuration information creation section that creates the stored configuration information with which a plurality of items of call setup configuration information and a plurality of indices; and
a transmitting section that, when the transmitting section receives the command message, transmits the stored configuration information to a radio communication terminal apparatus.

12. A radio communication terminal apparatus comprising:
a broadcast information receiving section that receives predefined configuration information;
a receiving section that receives stored configuration information with which a plurality of items of call setup configuration information and a plurality of indices;
a holding section that holds default configuration information, the predefined configuration information and the stored configuration information; and
a channel setup processing section that sets up a channel according to the stored configuration information,
wherein stored configuration information indices are associated with default configuration information indices and predefined configuration information indices.

13. A radio communication method comprising the steps of:
receiving a command message to transmit stored configuration information from a core network;
creating the stored configuration information associated with a plurality of items of call setup configuration information and a plurality of indices; and
transmitting the stored configuration information to a radio communication terminal apparatus when the command message is received.
